(19) United States
(12) Patent Application Publication
(10) Pub. No.: US 2020/0070772 A1
(43) Pub. Date: Mar. 5, 2020

(54) SYSTEMS AND METHODS FOR STATUS DETECTION AND REPORTING OF VEHICLE PASSENGER SEAT SAFETY DEVICES

(71) Applicant: PANASONIC AVIONICS CORPORATION, Lake Forest, CA (US)

(72) Inventors: Ryan K. Kim, Lake Forest, CA (US); Shankar L. Shastry, Irvine, CA (US)

(73) Assignee: PANASONIC AVIONICS CORPORATION, Lake Forest, CA (US)

(21) Appl. No.: 16/121,037

(22) Filed: Sep. 4, 2018

(51) Int. Cl. B60R 22/48; B60R 16/023; B60Q 9/00; B64D 45/00

(52) U.S. Cl. CPC B60R 22/48; B60R 16/0239; B60Q 9/00; B64D 11/062; B60R 2022/4866; B60R 2022/4816; B64D 45/00

(57) ABSTRACT

Systems and methods for detecting and reporting a status of safety devices installed in a vehicle having a plurality of seat groups, each seat group having a plurality of neighboring passenger seats. The seats are divided into seat groups. The system includes a plurality of safety devices disposed at the passenger seats and a plurality of safety device sensors coupled to the safety device which detect a safety status of the safety devices and output a signal representing the safety status. The sensors are operably coupled to an onboard management system. The onboard management system is configured to receive safety status signals based on the signals output by the sensors and generate and display on a display monitor a status screen indicating the status of the safety devices.

### BACKGROUND

The field of the invention generally relates to safety devices on passenger vehicles, such as seat belts on airplanes, trains, buses, etc., and, and more particularly, to systems and methods for detecting and reporting the status of the safety devices installed on a passenger vehicle.

Typically, passenger vehicles, such as airplanes, trains, buses, and automobiles have safety devices, such as seat belts. Some passenger vehicles also have other passenger safety device such as life vests, oxygen masks, and other devices. Especially on commercial passenger airplanes, the safety devices are inspected to confirm the presence, condition, and/or proper use of the safety devices. For example, a cabin crew member on a passenger plane may check that each passengers seat belt is properly fastened when required, such as for takeoff, landing, and when the fasten seat-belt indicator is on. In addition, airplanes flying having a certain flight path over water are generally required to have a life vest for every person. A crew member may perform a pre-flight inspection to confirm that each passenger seat is equipped with a life vest. If any life vests are missing, such life vests must be replaced or the passenger seat is not occupied on the flight. More comprehensive inspections of the life vests may be conducted on a periodic basis by maintenance crew or other authorized personnel. This more comprehensive inspection involves not only inspecting for the presence of the life vest, but also their expiration dates and whether they appear to have been tampered with. For example, a passenger or other unauthorized person may have removed, damaged an reinstalled the life vest, or otherwise tampered with the life vest. In this case, the life vest must be replaced and installed by authorized personnel.

The process of inspecting safety devices, such as seat belts, live vests, and other devices, is a time consuming task, especially on large commercial passenger vehicles which may have more than 100 seats, or even several hundred seats. Authorized personnel must walk to the location of each passenger seat and visually inspect the safety devices to determine the status of the safety device, such as the presence, condition, and/or proper use of the safety devices. Furthermore, the inspection only determines the status of the safety device at the instance of the inspection, whereas the status of the safety device can be different, immediately before or immediately after the inspection.

Various sensors for safety devices and systems for reporting the status of the safety devices have been previously disclosed and used. For example, essentially all new automobiles have seat belt warning systems for indicating when a seat belt is not properly fastened. The seat belt warning systems typically include seat belt sensors which detect whether a seat belt is properly fastened, and an indicator, such as a warning light or audible signal, coupled to the sensor which signals when a seat belt is not fastened.

However, previous systems for detecting and reporting the status of safety devices on a passenger vehicle are not suitable for larger passenger vehicles having many passenger seats. For example, such systems are not equipped to report the status of many passenger seats in a user-friendly and efficient manner. A crew member on a large passenger vehicle would have a difficult time locating and remedying an unfastened seat belt based on a warning light or audible signal. The location of the passenger seat is not easily identifiable, do not have a user interface capable of displaying the location of multiple seats having unfastened seat belts in the event of many seat belts being unfastened.

Furthermore, prior systems can be very expensive for use in larger passenger vehicles because they require an input to a reporting system from each of the sensor for each safety device. In a passenger vehicle having over 100 seats, this means over 100 inputs to the reporting system. This adds significant expense, and also weight, to the system, which is very important for commercial airplanes in which minimizing weight is a critical design factor.

Accordingly, improved systems and methods for detecting and reporting the status of safety device on a passenger vehicle are needed which overcome the deficiencies or prior systems.

### SUMMARY

In one embodiment, the present invention is directed to an innovative onboard safety device detection and reporting system for a passenger vehicle. The system is especially useful in larger passenger vehicles, such as commercial airliners, but may also be used in other passenger vehicles including passenger trains, buses, ships, boats and automobiles. The passenger vehicle has a plurality of passenger seats. The passenger seats are divided up into a plurality of seat groups such that each passenger seat is assigned to one seat group. Each seat group comprises a plurality of neighboring seats. For example, in an common airplane seat arrangement, a seat group may comprise adjacent seats in a row, such as the seats between an aisle and a window (e.g., three seats) on a single aisle airplane, and/or seats between aisles on a wide-body airplane having multiple two or more aisles.

The onboard safety device detection and reporting system comprises a plurality of first safety devices, such as a seatbelts. Each first safety device is installed at a respective passenger seat. A first safety device sensor is operably coupled to each respective first safety device. Each first safety device sensor is configured to detect a first safety status of the respective first safety device. For example, a seat belt sensor which detects whether a seat belt is properly fastened. Each first safety device sensor outputs a first signal representing the safety status of its respective first safety device. The first signal is a binary signal which indicates either a fault or a not fault condition of the first safety device. For instance, a seat belt sensor may output an open circuit for a fault condition indicating the seat belt is unfastened, and a closed circuit for a no fault condition indicating the seat belt is fastened.

The safety system also includes an onboard management system configured to manage the safety system, including receiving safety status signals based on the first signals output by the first safety device sensors and to report the status of the first safety devices on a display monitor a status screen so a user (e.g., a crew member on an airplane) can quickly and easily see a status of all of the first safety devices. The safety status signals are also binary signals, and may be the first signals themselves, or a different signal based upon the first signals. As described below, the first signals from the first safety device sensors in a seat group may be input into a junction device which receives the first signals and outputs a single safety status signal based on the first signals. Advantageously, this reduces the number of discrete inputs to the onboard management system required to operably couple all of the first safety device sensors to the onboard management system.

The onboard management system includes a system computer, system software configured to operate the safety system, and a display monitor operably coupled to the system computer. Within the safety system, each of the first safety sensors is associated with the respective seat group of the passenger seat at which it is installed. The first safety device sensors are operably coupled to the onboard management system. Each first safety device sensor may be directly coupled to a discrete input of the onboard management system, or alternatively, each first safety device sensor in a seat group may be connected to single discrete input of the onboard management system.

In one aspect of the present invention for connecting each of the first safety device sensors in a seat group to a single discrete input, each of the first safety device sensors in a respective seat group may be operably connected to a respective junction device having junction inputs for each of the first safety device sensors in a seat group and a junction output connected to the respective single discrete input of the onboard management system. Each of the junction devices is configured to receive the first signals from the first safety device sensors in its respective seat group, and output the safety status signal for the first safety device sensors of the respective seat group. Similar to the first signals, the safety status signal output of each junction device is a binary signal which indicates either a fault or a not fault condition of the first safety device sensors in the respective seat group. For example, each junction device may include logic, such as a logic circuit or a processor having firmware and/or software, that causes the safety status signal output by the junction device to be a fault when any one of the first signals from the first safety device sensors in the respective seat group is a fault. This would indicate that at least one of the first safety devices in the respective seat group has a fault condition, such as an unfastened seat belt.

The onboard management system is configured to receive the safety status signals and generate and display a status screen of the safety status of each of the passenger seats based on the safety status signals received by the onboard management system. Based on the safety status signals, the onboard management system associates each passenger seat, or seat group, with a fault condition or no fault condition. For example, in the case that the first safety device is a seat belt, the fault condition is an unfastened seat belt, and a no fault condition is a fastened seat belt. The onboard management system generates a status screen to display on the display monitor which shows the status of each of the passenger seats.

In another aspect, the status screen may be a graphical user interface which includes a layout of the passenger seats, such as icons for each passenger seat arranged to represent the layout in the passenger vehicle. The status screen also includes an indicator for the safety status of each respective passenger seat. For example, the status screen may be color coded in which passenger seats associated with a fault condition have a first color (e.g., red), and passenger seats associated with a no fault condition have a second color (e.g., green).

In the case that the safety status signals are for a seat group, the onboard management system associates each passenger seat in the group with the same safety status of the safety status signal for the seat group. Hence, based on the junction device logic, if the first signal from any one or more safety device sensors in a seat group is a fault, then the safety status signal is a fault, and the onboard management system associates the seat group with a fault condition. Conversely, if all of the first signals for a seat group are no fault, then the safety status signal is a no fault, and the onboard management system associates the seat group with a no fault condition.

In another feature, the onboard management system may also include a portable, handheld electronic device which is configured to wireless communicate with the system computer. The handheld electronic device has a display, such as an LCD, LED, or other suitable display, for displaying images. The onboard management system is configured to transmit the status screen to the handheld electronic device and the handheld electronic device is configured to display the status screen on its display. In this way, a crew member on the passenger vehicle can view the status screen throughout the passenger vehicle, and can go to the location of passenger seats displayed on the status screen as having fault conditions and take appropriate action.

In another aspect, the onboard management system further comprises a plurality of seat box modules, a seat box for each seat group. The seat boxes are distribution boxes installed at each seat group. Each of the seat boxes is operably connected to the system computer. Each seat box may include a networking switch, power supply and other electronics for providing communication between the system computer and entertainment modules installed at each seat, the seat box. For example, the onboard management system may include an in-flight entertainment system (IFE) in which the system computer includes a content server, entertainment system software, and a network controller. Each seat box has one or more discrete inputs for operably coupling the first safety device sensors to the seat box. In the case that a junction device is utilized for each seat group, all of the first safety device sensors in a respective seat group are connected to a respective junction device and the junction device is connected to a single discrete input of the respective seat box. In this way, each seat box only needs a single discrete input to operably couple the respective first safety device sensors for a seat group to the onboard management system.

In another aspect, the onboard safety device detection and reporting system for a passenger vehicle may further comprise a plurality of second safety devices, in which each second safety device is installed at a respective passenger seat. For example, the first safety device may be seat belts and the second safety devices may be life vests, other flotation devices, oxygen masks, etc. Each of the second safety devices are also monitored via a respective second safety device sensor operably coupled to a respective second safety device. The second safety device sensor are configured to detect a second safety status of the respective second safety device and to output a second signal representing the safety status of the respective second safety device. The second signal are of the same type as the first signal, and comprise a binary signal which indicates either a fault or a no fault condition of the second safety device;

Like the first safety device sensors, each second safety device sensor is associated with a respective one of the seat groups of the passenger seat at which it is installed, and each second safety device sensor is operably coupled to the onboard management system. The second safety device sensors are operably coupled to the onboard management system in the same manners as the first safety, including direct connection to the onboard management system, connection of each of the second safety devices in a seat group to a single discrete input, and/or connection of each of the second safety devices in a seat group to a junction device which is in turn connected to a single discrete input, connection via a seat box, etc.

The onboard management system is configured to receive a plurality of safety status signals based on the second signals output by the second safety device sensors and to display on the display monitor a status screen indicating a status of each of the second safety devices based on the safety status signals based on the second signals output by the second safety device sensors. The safety status signals are the same type of signal as those for the first safety device sensors. The status screen for the second safety devices may have the same features as the status screen for the first safety devices. Furthermore, the status screen for the second safety devices may be separate from the status screen for the first safety devices, or it may be combined with the same status screen. In other words, the status screen for the second safety devices may show only the safety status of the second safety devices, or it may show the safety status of both the first safety devices and the second safety devices on the same screen. As an example, the combined status screen may show the passenger seat layout, and each of the passenger seat icons can have a first portion of the icon (e.g., the top half/bottom half or left half/right half) displaying the status of the first safety device and a second portion of the icon displaying the status of the second safety device.

In still another aspect, the onboard safety device detection and reporting system for a passenger vehicle may further comprise one or more additional safety devices and respective safety device sensors installed at each respective passenger seat. The additional safety devices are configured, and operably coupled to the system, in the same manner as the first and second safety devices.

Another embodiment of the present invention is directed to methods of detecting and reporting the status of safety devices installed on a passenger vehicle having a plurality of passenger seats. The passenger seats are divided into a plurality of seat groups each having a plurality of neighboring passenger seats, and each passenger seat is assigned to one of the seat groups. The method comprises a plurality of first safety device sensors providing a first signal representing a safety status of a respective first safety device operably coupled to the respective first safety device sensor. The first signal is the same as the first signal described above with respect to the system embodiment.

An onboard management system receives a plurality of safety status signals based on the first signals. The safety status signals are the same as the safety status signals described above with respect to the system embodiment. The onboard management system assigns a fault condition or no fault condition to each passenger seat (to each first safety device sensor and respective first safety device), or seat group, based on the safety status signals.

The onboard management system generates a status screen of the safety status of each of the passenger seats based on the safety status signals received by the onboard management system. The onboard management system then displays the status screen on a display monitor of the onboard management system. The status screen is the same status screen described above with respect to the system embodiment.

In another aspect, the method may further comprise a respective junction device for each seat group receiving the first signals from the respective first safety device sensors in the respective seat group. Each junction device then generates the safety status signal based on the first signals received from the respective first safety device sensors in the respective seat group. Each junction device outputs the respective safety status signal to the onboard management system. The junction devices may be the same junction devices as described above with respect to the system embodiment.

In still another aspect, the method may further comprise a respective seat box module for each seat group receiving the first signals from respective first safety device sensor in the respective seat group. Each seat box module generating a respective safety status signal based on the respective first signals, and transmitting the safety status signal to a system computer of the onboard management system.

In additional aspects of the method embodiment, the method may include any one or more of the features and functionality of the system embodiment, described herein. For example, the method may also include the use of additional safety devices (e.g., second safety devices, etc.) and second safety device sensors (e.g., second safety device sensor, etc.), communicating the status screen to a handheld electronic device and displaying the status screen on the handheld electronic device,

### BRIEF DESCRIPTION OF THE DRAWINGS

The foregoing and other aspects of embodiments are described in further detail with reference to the accompanying drawings, wherein like reference numerals refer to like elements and the description for like elements shall be applicable for all described embodiments wherever relevant, wherein:

FIG. 1 is a block schematic diagram of an onboard safety device detection and reporting system installed on an airplane, according to one embodiment of the present invention;

FIG. 2 is a block schematic diagram of the onboard safety device detection and reporting system of FIG. 1;

FIG. 3 is a block schematic diagram of an onboard safety device detection and reporting system of FIG. 1, according to another embodiment of the present invention;

FIG. 4 is a block diagram of a computing device (computer) which may be utilized in the onboard management system and/or the handheld electronic device of FIGS. 1-3.

FIG. 5 illustrates a status screen showing the status of the seat belts for each passenger seat, according to one embodiment of the present invention;

FIG. 6 illustrates a status screen showing the status of the life vests for each passenger seat, according to one embodiment of the present invention;

FIG. 7 illustrates a status screen showing the status of the seat belts and life vests for each passenger seat, according to one embodiment of the present invention.

### DETAILED DESCRIPTION

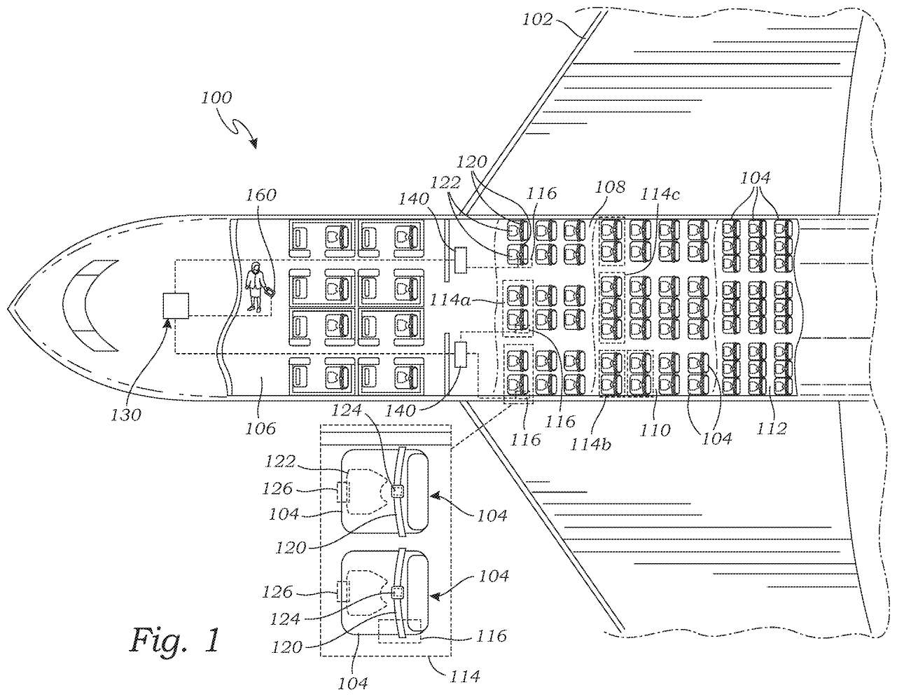

The present invention is directed to systems and methods for detecting and reporting status of the safety devices installed on a passenger vehicle having a plurality of passenger seats. Referring to FIG. 1, a schematic diagram of one embodiment of an onboard safety device detection and reporting system 100 for a passenger vehicle 102 is shown. The embodiments described and shown in the drawings are directed to systems and methods for a system installed on an airplane 102, but it is to be understood that the present invention is not limited to airplanes, but may be installed on any suitable passenger vehicle, including trains, buses, ships, boats, automobiles, etc.

The airplane 102 has a passenger cabin having a plurality of passenger seats 104 arranged according to a passenger seat layout. In the example of FIG. 1, a front cabin 106 of the cabin (e.g., first class cabin) is arranged in a 1-2-1. In other words, going across a row, there is one window seat, then a first aisle, then 2 adjacent seats, then a second aisle and then another window seat. In the next cabin 108, the seats are arranged in a 2-2-2 seat arrangement. In other words, there are 2 adjacent seats, then a first aisle, then 2 adjacent seats, then a second aisle and then 2 more adjacent seats. In the next cabin 110, the seats are arranged in a 2-3-2 seat arrangement. In the next cabin 112, the seats are arranged in a 2-3-2 seat arrangement. The schematic of FIG. 1 shows only a few of the rows of seats in each cabin, with the understanding that the number of rows may vary according to the type of airplane and seat particular seat layout of the airplane. For example, some airplanes have rows arranged 3-3 (i.e., a single aisle), or 3-2-3, or 2-3-2, or 3-4-3, etc.

The seats 104 are grouped into a plurality of seat groups 114, such that each seat 104 is assigned to one of the seat groups 114. Each seat group 114 includes a plurality of neighboring seats 104, such as adjacent seats 104 in one or more rows. In the example of FIG. 1, the seats 104 are assigned to seat groups 114 comprising the seats 104 in the same row separated by the aisles of the cabin 108. For example, seat group 114a includes 2 seats 104 in the same row between the window and the first aisle. Seat group 114b includes the 4 seats 104 between the window and the first aisle in two adjacent rows. Seat group 114c includes the 3 seats in a single row between the first and second aisles. To avoid too much clutter in FIG. 1, not all of the seat groups are identified. However, it is understood that all of the seats 104 are assigned to one of the seat groups 114.

The seat groups 114 may be assigned to conveniently connect to a respective seat box module 116 for the seat group 114. For instance, each seat group 114 may have an individual seat box module 116 for the particular seat group 114. Each seat box module 116 is installed at one of the seats 104 of the respective seat group 114, such as under the seat 104. The seat groups 114 may be sized with a number of seats 104 which may be accommodated by a seat box module 116.

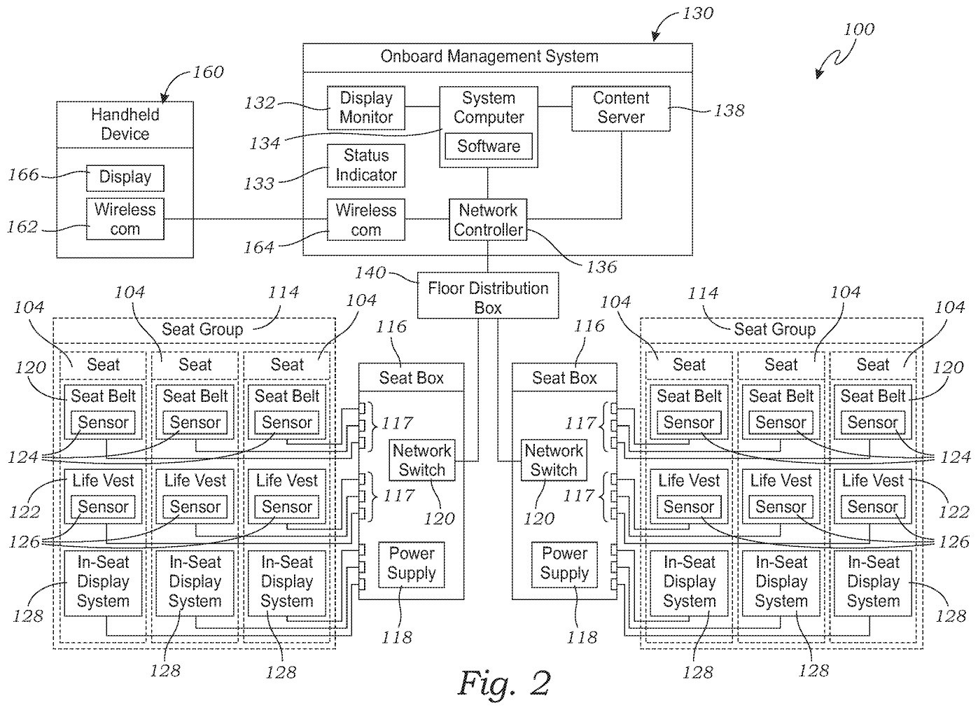

As depicted in FIGS. 1 and 2, each seat 104 is equipped with safety devices, including a seat belt 120 and a life vest 122. Each of the seat belts 120 has a respective seat belt sensor 124. The seat belt sensors 124 are configured to detect whether the seat belt 120 is properly fastened. Each seat belt sensor 124 outputs a first signal which represents the safety status of the seat belt 120, namely, fastened or unfastened. The first signal is a binary signal which outputs only one of two possible signals, a no fault signal when the seat belt 120 is fastened and a fault signal when the seat belt 120 is not fastened. As one example, the seat belt sensor 124 may be configured to close a circuit when the seat belt is fastened, and open the circuit when the seat belt is not fastened. In this case, when the seat belt 120 is fastened, the first signal is a closed circuit (no fault signal) indicating the seat belt 120 is fastened, and when the seat belt 120 is unfastened, the first signal is an open circuit indicating the seat belt 120 is not fastened.

Similarly, each of the life vests 122 is equipped with a respective life vest sensor 126. Each life vest sensor 126 is configured to detect tampering with the life vest 126. For instance, the life vest sensor 126 may be configured to detect whether the life vest 122 is removed from a compartment under the seat 104 in which the life vest 122 is stored at each seat 104. Each life vest sensor 126 outputs a second signal which represents the safety status of the respective life vest 126. The safety status of a life vests 126 may indicate that the life vest is being tampered with or that it is not being tampered with. Like the first signal, the second signal is also a binary signal which outputs only one of two possible signals, a no fault signal when the life vest 126 is not tampered with, and a fault signal when the life vest 122 is not fastened. For example, the life vest sensor 126 may be configured to close a circuit when the life vest compartment is closed, and open the circuit when the life vest compartment is not opened. In this case, when the seat life vest compartment is closed, the second signal remains a closed circuit (no fault signal) indicating the life vest 122 is not being tampered with, and when the life vest compartment is opened, the second signal is an open circuit indicating the life vest 122 is being tampered with.

Each seat 104 also has a respective in-seat display system 128. The in-seat display system 128 is part of an onboard entertainment system (e.g., an in-flight entertainment system “IFE”). The in-seat display system 128 includes a display monitor, a controller for a passenger to control the in-seat display system 128, and may include additional features, such as charging port(s), headphone jack(s), etc. The in-seat display system 128 for each seat 104 may be installed in the seatback of the and/or on cabin walls, deployable from an armrest, etc.

As shown in the FIGS. 1 and 2, the onboard safety device system 100 also includes an onboard management system 130 which is configured to manage the safety device system 100, including receiving the first signals from the seat belt sensors 124 and second signals from the life vest sensors 126, and reporting the status of the seat belts 120 and life vests 122 on a status screen displayed on a display monitor 132 of the onboard management system 130. The onboard management system 130 includes a system computer 134 having system software 136 for configured to operate the onboard management system 130. The display monitor 132 is operably coupled to the system computer 134. The display monitor 132 is a crew member monitor for a cabin crew member to interface with onboard management system 130. The onboard management system 130 may also include a network controller 136 for communicating with the seat box modules 116.

The onboard management system 130 also may include a content server 138 which stores media content and distributes the media to the in-seat display systems 128 via the communication network comprising the network controller 136, and network switches 120 of the seat box modules 116.

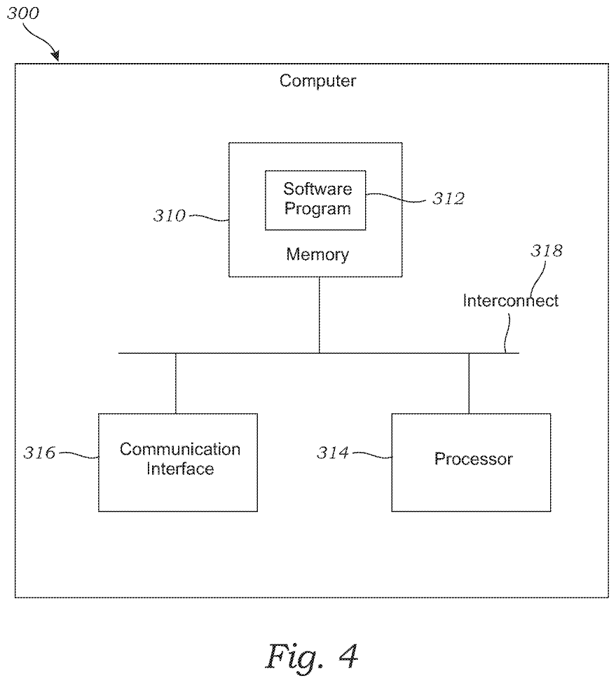

FIG. 4 generally shows a block diagram of the components of an example of a computer (computing device) 300 that may be used as the system computer 134 in the onboard management system 130 and/or the content server 138 in the onboard safety device system 100 of FIGS. 1 and 2. The computer 300 includes memory 310, an application software program 312, a processor or controller 314 to execute the application software 312, a network or communications interface 316, e.g., for communications with a network or interconnect 218 between the components. The memory 310 may be or include one or more of cache, RAM, ROM, SRAM, DRAM, RDRAM, EEPROM, SDRAM and other types of volatile or non-volatile memory capable of storing data. The processor or controller 314 may be or include multiple processors, a single threaded processor, a multi-threaded processor, a multi-core processor, or other type of processor capable of processing data. Depending on the particular system component (e.g., whether the component is a computer or a hand held mobile communications device), the interconnect 318 may include a system bus, LDT, PCI, ISA, or other types of buses, and the communications or network interface may, for example, be an Ethernet interface, a Frame Relay interface, or other interface. The network interface 316 may be configured to enable a system component to communicate with other system components across a network which may be a wireless network or various other communication networks. It should be noted that one or more components of computer 300 may be located remotely and accessed via a network. Accordingly, the system configuration provided in FIG. 4 is provided to generally illustrate how embodiments may be configured and implemented.

The onboard management system may also include a plurality of seat box modules 116, such as one seat box module 116 for each seat group 114. Each seat box module 116 is operably coupled to the onboard management system 130. The seat box modules 116 may be operably connected directly to the onboard management system 130, or they may be connected to a respective floor distribution box 140 which is in turn operably connected to the onboard management system 130. Each seat box module 116 includes a power supply 118 and network switch 120 which can provide power and network communications for each of the in-seat display systems 128 in the respective seat group 114. The seat box modules 116 also include one or more discrete inputs 117 for inputting discrete inputs, such as binary signals, for monitoring or controlling onboard devices, including the seat belt sensors 124 and life vest sensors 126.

The onboard management system 130 may also include one or more floor distribution boxes 140. Each floor distribution box 140 is operably connected to a plurality of seat box modules 116, and to the onboard management system 130. The floor distribution boxes 140 are configured to distribute power to the seat box modules 116, and distribute network communications between the seat box modules 116, the system computer 134 and the content server 138. The floor distribution boxes 140 may include one or more network switches, power switches, inverters, converters, etc.

In one embodiment, the onboard management system 130 may comprise, or be integrated with, an onboard entertainment system, such as an in-flight entertainment system, or other onboard system. Alternatively, the onboard management system 130 may be a stand-alone system.

The block schematic diagram of FIG. 2 illustrates the onboard management system 130 connected to two of the seat groups 114 of FIG. 1. It is understood that the onboard safety system 100 of FIG. 1 includes additional seat groups 114, and seat box modules 116 for each of the other seat groups 114. As shown in FIG. 2, each of the seat belt sensors 124 and life vest sensors 126 is operably connected to a discrete input 117 of a respective seat box module 116. The seat box modules 116 may be configured to simply pass through the first signals and second signals from the seat belt sensors 124 and life vest sensors 126, respectively, to the system computer 134, or they may be configured to process the signals and output a safety status signal based upon the first signals and second signals. For instance, a seat box module 116 may receive the first signals from the seat belt sensors 124 in the seat group 114 connected to the seat box module 116, and then transmit the first signals to the system computer 134. Alternatively, the seat box module 116 may receive the first signals from the seat belt sensors 124 in the seat group 114 connected to the seat box module 116, and then generate a safety status signal for the entire seat group 114. For instance, the seat box module 116 may include logic in which the safety status signal is a fault if any one or more of the first signals is a fault, and the safety status signal is a no fault if all of the first signals are a no fault. The safety status signal may be a binary signal (fault signal or no fault signal), same as, or similar to, the first and second signals, which indicates either a fault condition (indicating seat belt unfastened, or life vest tampered) or a no fault condition (indicating seat belt fastened, or life vest not tampered). Of course, the seat box modules 116 may be configured to process the second signals from the life vest sensors 126 in the same way.

The system computer 134 is configured to receive the safety status signals from each of the seat box modules 116 and to generate one or more status screen(s) of the status of seat belt sensors 124 and life vest sensors 126 at each of the passenger seats 104. The system computer 134 displays the status screen(s) on the display monitor 132. In order to generate the status screen(s), the system computer 134 is configured to associate each passenger seat 104 or seat group 114, with a fault condition or no fault condition, based on the safety status signals received by the system computer 134. For the seat belt 120 status, a fault condition is assigned for a fault signal indicating an unfastened seat belt 104 and a no fault condition is assigned for a no fault signal indicating a fastened seat belt 104. For the life vests 122, a fault condition is assigned for a tampered life vest 122 and a not fault condition is assigned for non-tampered life vest.

As explained herein, the safety status signal may be for each individual passenger seat 104, or it may be for all of the passenger seats 104 in a seat group 114. In the case of individual passenger seats 104, the system computer 134 assigns a safety status to each individual seat, either a fault condition or no fault condition, based on the safety status signal. In the case of a seat group safety status signal, the system computer 134 assigns the same safety status to all of the passenger seats 104 in the respective seat group 114.

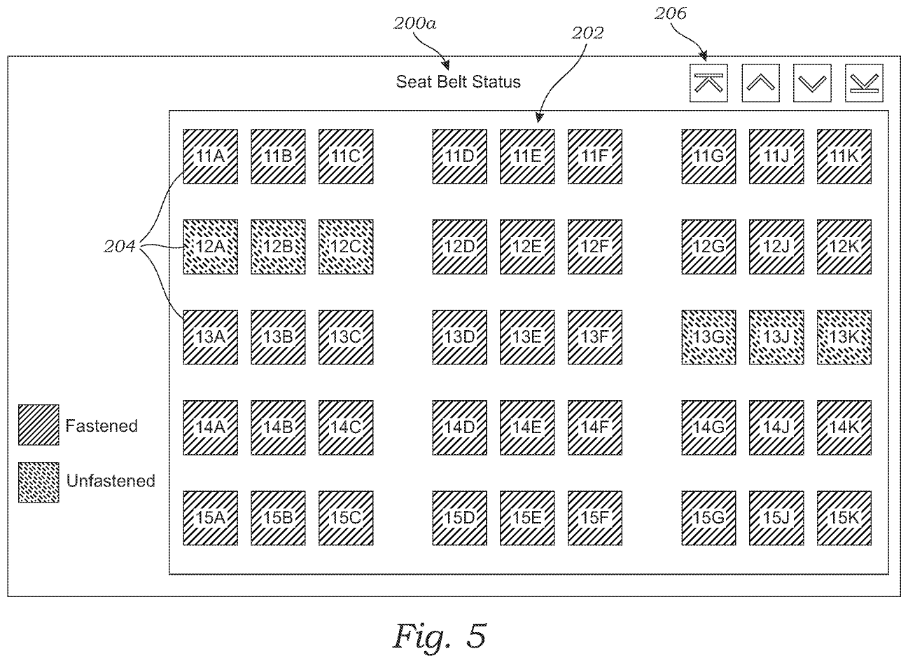

The system computer 134 then generates one or more status screen(s) 200, as shown in FIGS. 5-7. Referring to FIG. 5, a status screen 200a showing the status of the seat belts 120 for each passenger seat 104 is shown. The status screen 200a has a passenger seat layout 202 which includes seat icons 204 arranged to emulate the actual layout of the passenger seats 104 in the airplane 102. For example, the icons 204 have the same number of seats 104 row, and arranged in a pattern similar to the seat layout of the airplane. The icons 204 may also include a seat identifier, such as the row number and seat letter of the seat 104 in the airplane 102. The status screen 200a also has a safety status indicator which indicates the safety status assigned by the system computer 134 to each respective seat 104. In the examples of FIGS. 5-7, the indicator is a color of the icon. The icons 204 for the seats 104 associated with a fault condition (unfastened seat belt) have a first color (red), and the seats 104 associated with a no fault condition (fastened seat belt) are green. The status screen 200a also has user interface controls 204 for scrolling up and down the layout, and paging forward and backward through the layout.

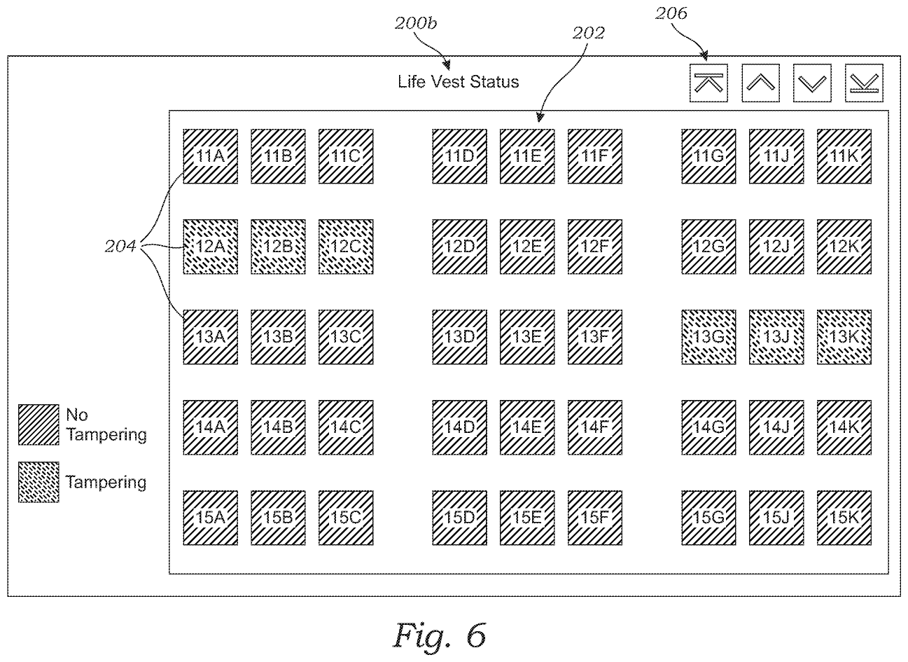

Turning to FIG. 6, a status screen 200b showing the status of the life vests 122 for each passenger seat 104 is shown. The status screen 200b is basically the same as the status screen 200a for the seat belts 120, except that it shows the status of the life vests 122. Thus, the icons 204 for the seats 104 associated with a fault condition (life vest tampered) have a first color (e.g., red), and the seats 104 associated with a no fault condition (life vest not tampered) have second color different from the first color (e.g., green).

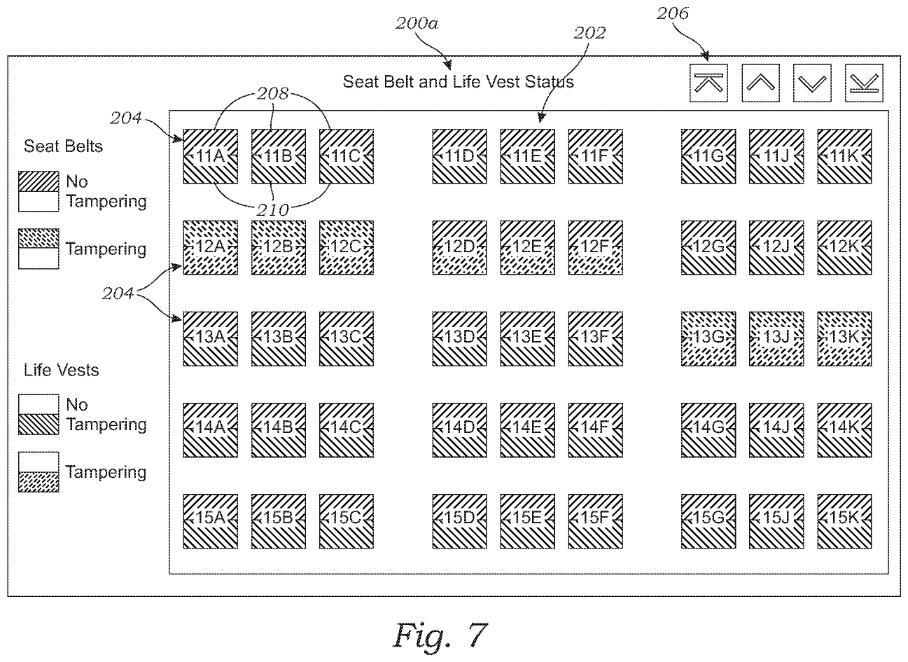

FIG. 7 show another example of a status screen 200c showing the status of both the seat belt 122 and the life vest 124 for each respective passenger seat 104. The status screen 200c is similar to the status screens 200a and 200b, except that the status screen 200c shows the status of both the seat belt 122 and the life vest 124. The icons 204 are split between a seat belt portion 208 (the top half) and a life vest portion 210 (the bottom half). The seat belt portion 208 shows the safety status of the seat belts 122 for each passenger seat 104 in the same fashion as the status screen 200a, and the life vest portion 210 shows the safety status of the life vests 122 for each passenger seat in the same fashion as the status screen 200c.

The onboard management system 130 may also include a status indicator 133 which indicates a safety status event regarding the status of the seat belt sensors 124 and/or life vest sensors 126. The status indicator 133 may be multi-color light, a small display (e.g., an LCD, or LED display) or other visual indicator which provides a warning when there is safety status event, such as a life vest sensor 126 showing a fault condition, or a seat belt sensor 124 showing a fault condition or changing from a no fault condition to a fault condition. The status indicator 133 may be located on or near the display monitor 132 so that a crew member can easily see the indicator. For instance, the status indicator 133 may be a multi-color light that lights up a first color (e.g., green) to indicate a no fault condition for all of the seat belt sensors 124 and/or all of the life vest sensors (126), lights up a second color (e.g., red) when there is a fault condition in any one or more of the seat belt sensors 124, and/or lights up a third color (e.g., yellow) when there is a fault condition with any one or more of the life vest sensors 126.

The system computer 134 may be configured to allow a user to select between each of the status screens 200a, 200b, 200c. In this way, a user can view the status of the seat belts 122, or the status of the life vests 124, or the status of both.

In another aspect, the onboard safety system 100 may also be configured to utilize a portable, handheld electronic device 160 for allowing a user to wireless communicate with the system, such as viewing the status screens 200, receiving status notifications, and performing any other functions of the user interface for system computer 134. The handheld electronic device 160 may be a smartphone, tablet computer, or the like. The electronic device 160 has a wireless communication module 162 for wireless communicating with a wireless communication module 164 of the onboard management system 130. The wireless communication modules 162, 164 may be configured for any suitable wireless communication protocol, such as WiFi, Bluetooth, cellular phone, etc. The electronic device 160 also has a display 166, such as an LCD, LED or other suitable display. The display 166 may be a touchscreen display. The onboard management system 130 is configured to transmit the status screens 200 to the electronic device 160. The electronic device 160 is configured to display the status screens 200 on the display 166, and allow the user to utilize any of the same functionality of the status screens 200 as the display monitor 132. The electronic device 160 may also be configured to provide a safety status notification, such as an audible tone or vibrate mode to provide a warning when there is safety status event, same or similar to the status indicator 133.

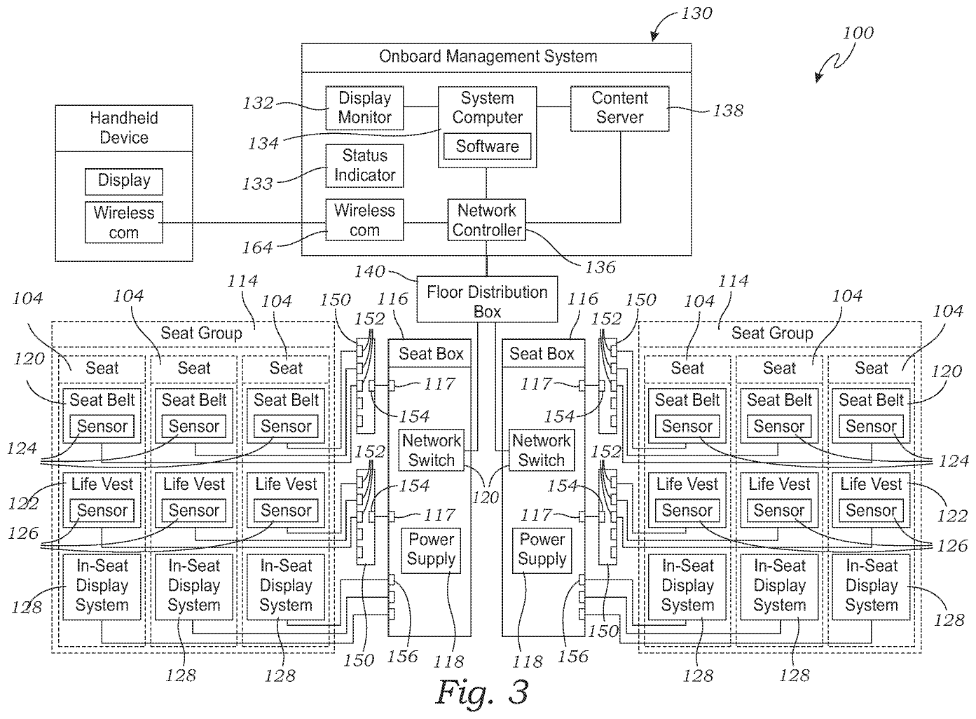

Turning now to FIG. 3, a diagram of another embodiment of an onboard safety device detection and reporting system 100b for a passenger vehicle 102 is shown. The onboard safety device system 100b is the same as the onboard safety system 100a, except that the system 100b includes a plurality of junction devices 150 for connecting each of the seat belt sensors 124 in a seat group 114 to a single discrete input 117 of the seat box module 116, and connecting each of the life vest sensors 126 in a seat group 114 to a single discrete input 117 of the seat box module 116. As shown in FIG. 3, each of the seat belt sensors 124 in a respective seat group 114 is operably connected to a respective junction device 150. Each junction device 150 has a plurality of junction inputs 152, wherein each junction input 152 is connected to a respective seat belt sensor 124 in a seat group 114. Each junction device 150 has a junction output 154 connected to a respective single discrete input 156 of the seat box module 116 (or a single discrete input 156 of the onboard management system 130). Each of the junction devices 150 is configured to receive the first signals from the seat belt sensors 124 in its respective seat group, and output the safety status signal for the seat belt sensors 124 of the respective seat group 114. Similar to the first signals, the safety status signal output of each junction device 150 is a binary signal which indicates either a fault or a not fault condition of the seat belt sensors 124 in the respective seat group 114. Each junction device 150 includes logic, which may be in the form of a logic circuit or a processor having firmware and/or software, that causes the safety status signal output by the junction device 150 to be a fault signal when any one of the first signals from the seat belt sensors 124 in the respective seat group 114 is a fault. This would indicate that at least one of the seat belts 120 in the respective seat group is unfastened. The logic is also be configured to cause the safety status signal output by the junction device to be a no fault signal when all of the first signals from the seat belt sensors 124 in the respective seat group 114 is a no fault, indicating that all of the seat belts 120 in the seat group 114 are fastened.

Also as shown in FIG. 3, each of the life vest sensors 124 in a respective seat group 114 is operably connected to a respective junction device 150. The junction devices 150 connected to the life vest sensors 126 are configured similarly to the junction devices 150 connected to the seat belt sensors 124, in order to output a safety status signal based on the second signals from the life vest sensors 126 in respective seat group 114.

In the embodiment of FIG. 3, the safety status signal of the onboard safety device system 100b is an indication for all of the passenger seats 104 in a seat group 114. Accordingly, the system computer 134 utilizes a group safety status and therefore assigns the same safety status to all of the passenger seats 104 in a respective seat group 114.

The operation and features of the onboard safety device system 100b includes all of the features and functionality described herein for the onboard safety device system 100a.

Although particular embodiments have been shown and described, it is to be understood that the above description is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims. For example, not all of the components described in the embodiments are necessary, and the invention may include any suitable combinations of the described components, and the general shapes and relative sizes of the components of the invention may be modified. Accordingly, embodiments are intended to exemplify alternatives, modifications, and equivalents that may fall within the scope of the claims. The invention, therefore, should not be limited, except to the following claims, and their equivalents.

1. A system for detecting and reporting a status of safety devices installed in a vehicle having a plurality of seat groups, each seat group having a plurality of neighboring passenger seats, the system comprising:
a plurality of first safety devices, each first safety device disposed at a respective passenger seat;
a plurality of first safety device sensors, each first safety device sensor operably coupled to a respective first safety device and configured to detect a first safety status of the respective first safety device and to output a first signal representing the safety status of the respective first safety device, wherein the first signal comprises a binary signal which indicates either a fault or a no fault condition of the first safety device;
each first safety sensor associated with a respective one of the seat groups; and
an onboard management system comprising a system computer, system software and a display monitor;
wherein for each seat group, the system is configured to process the respective first signals to generate a single discrete safety status signal representing a single status of the first safety devices for the seat group for input to the onboard management system, the safety status signal comprising a binary signal which indicates either a fault or a no fault condition of the first safety devices for the respective seat group, and the onboard management system is configured to receive the safety status signals for each seat group and to display on the display monitor a status screen indicating a status of each of the first safety devices based on the safety status signals.

2. The system of claim 1, wherein:
each of the safety status signals corresponds to a respective seat group, and the status screen indicates a respective status of each passenger seat based on the safety status signal of the respective seat group.

3. (canceled)

4. The system of claim 1, further comprising a plurality of junction modules, each junction module having junction inputs operably connected to a respective group of first safety device sensors in a respective seat group and a junction output connected to the onboard management system, wherein each junction module is configured to receive the first signals from the connected first safety sensor and output the safety status signal of the respective seat group.

5. The system of claim 4, wherein each junction module comprises logic that causes the safety status signal output by the junction module to be a fault when at least one of the first signals is a fault.

6. The system of claim 5, wherein the logic causes the safety status signal output by the junction module to be a no fault when all of the first signals are no fault.

7. The system of claim 1, wherein:
the onboard management system comprises a plurality of seat box modules, each seat box module in network communication with the system computer and operably coupled to each of the first safety device sensors in a respective seat group; and
wherein each seat box module is configured to receive the first signals from the respective first safety device sensors in the respective seat group and to transmit the safety status signal based on the first signals output by the respective first safety devices.

8. The system of claim 1, wherein:
the onboard management system comprises a plurality of seat box modules, each seat box module in network communication with the system computer and operably coupled to each of the first safety device sensors in a respective seat group via a respective junction module, each junction module having junction inputs operably connected to the respective the first safety device sensors in a respective seat group and a junction output connected to a single discrete input for the respective seat box, wherein each junction module is configured to receive the first signals from the connected first safety device sensors and output the safety status signal of the respective seat group.

9. The system of claim 8, wherein each junction module comprises logic that causes the safety status signal output by the junction module to be a fault when at least one of the first signals.

10. The system of claim 9, wherein the logic causes the safety status signal output by the junction module to be a no fault when all of the first signals are no fault.

11. The system of claim 1, wherein the first safety devices are seatbelts, and the first safety device sensors are seat belt sensors each configured to output the respective first signal indicating whether the respective seat belt is fastened or unfastened.

12. The system of claim 1, further comprising:
a plurality of second safety devices, each second safety device disposed at a respective passenger seat;
a plurality of second safety device sensors, each second safety device sensor operably coupled to a respective second safety device and configured to detect a second safety status of the respective second safety device and to output a second signal representing the safety status of the respective second safety device, wherein the second signal comprises a binary signal which indicates either a fault or a no fault condition of the second safety device;
each second safety device sensor associated with a respective one of the seat groups; and
wherein each second safety device sensor is operably coupled to the onboard management system, and the onboard management system is configured to receive a plurality of safety status signals based on the second signals output by the second safety device sensors and to display on the display monitor a status screen indicating a status of each of the second safety devices based on the safety status signals based on the second signals output by the second safety device sensors, and wherein the safety status signals based on the second signals output by the second safety device sensors each comprise a binary signal which indicates either a fault or a no fault condition of the respective second safety devices.

13. The system of claim 12, wherein:
the first safety devices are seatbelts, and the first safety device sensors are seat belt sensors each configured to output the respective first signal indicating whether the respective seat belt is fastened or unfastened; and
the second safety devices are life vests, and the second safety device sensors are life vest sensors each configured to output the respective second signal indicating whether the respective life vest is properly installed at the respective passenger seat.

14. The system of claim 1, wherein the status screen includes a layout of the passenger seats showing an icon representing each of the passenger seats and the status of the respective first safety device disposed at each passenger seat indicated at the location of the icon for such passenger seat.

15. The system of claim 14, wherein the status of each first safety device is indicated by a color coding in which a fault status is indicated by a first color and a no fault status is indicated by a second color different than the first color.

16. The system of claim 1, wherein the onboard management system is installed on the vehicle and the vehicle is an airplane.

17. The system of claim 10, wherein the onboard management system is installed on the vehicle and the vehicle is an airplane.

18-20. (canceled)
